(19) United States
(12) Patent Application Publication
(10) Pub. No.: US 2009/0152875 A1
(43) Pub. Date: Jun. 18, 2009

(54) Adjustable Backset lockset

(76) Inventors: John Steven Gray, Maryville, TN (US); Thomas Allen Harris, Charlotte, NC (US)

Correspondence Address: MOORE & VAN ALLEN PLLC, P.O. BOX 13706, Research Triangle Park, NC, 27709, US

(21) Appl. No.: 11/956,104

(22) Filed: Dec. 13, 2007

(51) Int. Cl. E05C 1/08

(52) U.S. Cl. 292/1.5

(57) ABSTRACT

A lock assembly comprises a housing and a latchbolt including an attachment member. A retractor element is disposed within the housing for linear reciprocating movement. The retractor element includes a first attachment location at a first position relative to the axis of reciprocation of the retractor element and a second attachment location at a second position relative to the axis of reciprocation of the retractor element. The second attachment location is spaced from the first attachment location by a distance along the axis of reciprocation of the retractor element. The attachment member of the latchbolt is selectively engageable with the retractor element at either the first attachment location or the second attachment location for movement together with the retractor element. An operator is operatively connected to the retractor element for facilitating selective reciprocation of the retractor element for moving the latchbolt between a latched position and an unlatched position.

### BACKGROUND

This invention relates generally to a lockset for use with a door, and more particularly to a lockset with an adjustable backset distance for use with doors having different backset distances.

“Backset” is the distance between the edge of a door and the relatively transverse axis of rotation about which the latch operator moves for extending and retracting a latch bolt of a latch mechanism. Backset has been standardized by the industry. Standard backsets for commercial door openings are 2⅜ inches and 2¾ inches.

Manufacturers of latch constructions have satisfied the demand for latchsets having standard backset measurements by producing and marketing two different models of latch constructions. However, maintaining an inventory of assemblies and components for locksets having two different backsets is inefficient.

An alternative is providing adjustable latch mechanisms, which have become an accepted feature of tubular locksets. Unfortunately, adjustable latch mechanism solutions for this application have typically been of insufficient strength for a Grade 2 commercial lockset capable of meeting ANSI standards.

For the foregoing reasons, there is a need for a new lockset which is easily adjusted for mounting on doors of differing backset distances. Such adjustment should be effected in a way that provides the assembly with inherent strength. Ideally, the new lockset construction would allow for relatively quick and easy selective adjustment between the two standard backset measurements.

### SUMMARY

According to the present invention, a lock assembly is provided comprising a housing and a latchbolt including an attachment member. A retractor element is disposed within the housing for linear reciprocating movement. The retractor element includes a first attachment location formed in the retractor element in a first position relative to the axis of reciprocation of the retractor element and a second attachment location formed in the retractor element in a second position relative to the axis of reciprocation of the retractor element. The second attachment location is spaced from the first attachment location by a distance along the axis of reciprocation of the retractor element. The attachment member of the latchbolt is selectively engageable with the retractor element at either the first attachment location or the second attachment location for movement together with the retractor element. An operator is operatively connected to the retractor element for facilitating selective reciprocation of the retractor element for moving the latchbolt between a latched position and an unlatched position.

### BRIEF DESCRIPTION OF THE DRAWINGS

For a more complete understanding of the present invention, reference should now be had to the embodiments shown in the accompanying drawings and described below. In the drawings:

FIG. 1 is an exploded perspective view of a lockset assembly according to an embodiment of the present invention.

FIG. 2 is a close-up perspective view of a lock body as shown in FIG. 1.

FIG. 3 is an exploded perspective view of the lock body shown in FIG. 2.

FIG. 4 is an elevated plan view of a latch retractor as shown in FIG. 3 and a latch assembly according to an embodiment of the present invention.

FIG. 5 is a perspective view of a latchbolt assembly according to an embodiment of the present invention.

FIG. 6 is an exploded perspective view of the latchbolt assembly shown in FIG. 5.

FIG. 7 is an exploded perspective view of a latch retractor as shown in FIG. 4 and a latch assembly according to an embodiment of the present invention.

FIG. 8 is an elevated plan view of the latch retractor and the latch assembly as shown in FIG. 7.

### DESCRIPTION

The adjustable backset arrangement according to the present invention is for use in a conventional lockset such as, for example, the locksets described by U.S. Pat. No. 4,920,773 and U.S. Pat. No. 6,131,970, the contents of both of which are incorporated herein by reference. Moreover, it is understood that the overall construction of the lockset assembly is not critical to the present invention and, for purposes of illustration, may be as described herein or in the above-referenced U.S. patents. Accordingly, although the present invention will be described in detail herein with reference to an exemplary embodiment of an adjustable backset function, detailed explanations of the functioning of all of the lockset components are deemed unnecessary for understanding of the present invention by one of ordinary skill in the art.

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

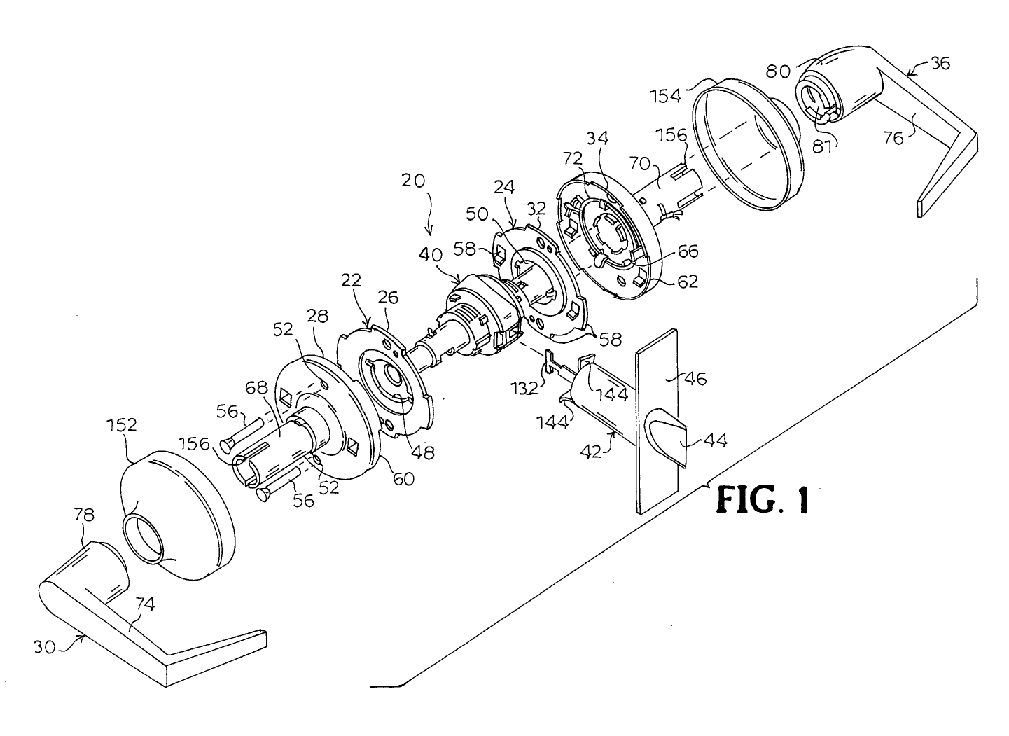

Referring now to the drawings, wherein like reference numerals designate corresponding or similar elements throughout the several views, a cylindrical lockset assembly for use with a conventional opening in a door (not shown) is shown in FIG. 1 and generally designated at 20. The cylindrical lockset assembly 20 comprises an inside subassembly 22 and an outside subassembly 24. The inside subassembly 22 includes a rose plate 26, a rose 28, and a lever 30. The outside subassembly 24 includes a rose plate 32, a rose 34, and a lever 36. A chassis 40 is located between the inside subassembly 22 and the outside subassembly 24. A latch assembly 42 is positioned for operable attachment to the chassis 40 and includes a latchbolt 44 which extends outwardly from a face plate 46 in an extended, or latched, position.

The rose plates 26, 32 are each formed in a generally circular configuration and having an axial central opening 48, 50. Two pair of holes 52, 54 are formed on the periphery of each rose plate 26, 32. One pair of holes 52 are adapted to pass bolts 56 which extend through the door. The other pair of holes is provided for receiving screws (not shown) for fastening the rose plates 26, 32 to their respective roses 28, 34. A pair of inwardly extending tabs 58 are formed in the outside rose plate 32 by punching holes through the outside rose plate 32.

The roses 28, 34 are each formed in a generally circular configuration and include a side wall 60, 62 defining an inner dish-like cavity in the inside surface of the rose 28, 34. An axial opening 64, 66 is formed through each rose 28, 34 and extends through rotating spindles 68, 70 which extend outwardly from the roses. A return spring 72 is positioned in the cavity of each rose 28, 34. As described above, the rose plates 26, 32 are fastened to the roses 28, 34 using screws for retaining the springs 72 within the cavity.

The levers 30, 36 each include a handle 74, 76 which is formed integrally with a hub 78, 80. Each hub 78, 80 has an axial opening 81 which, in a locking lockset, may communicate with an axial opening formed through the handle for receiving a turn button or lock cylinder for locking of the latchbolt in the extended, or latched, position. Further, although levers are shown, it is understood that other latch operating means are suitable, such as a doorknob or the like.

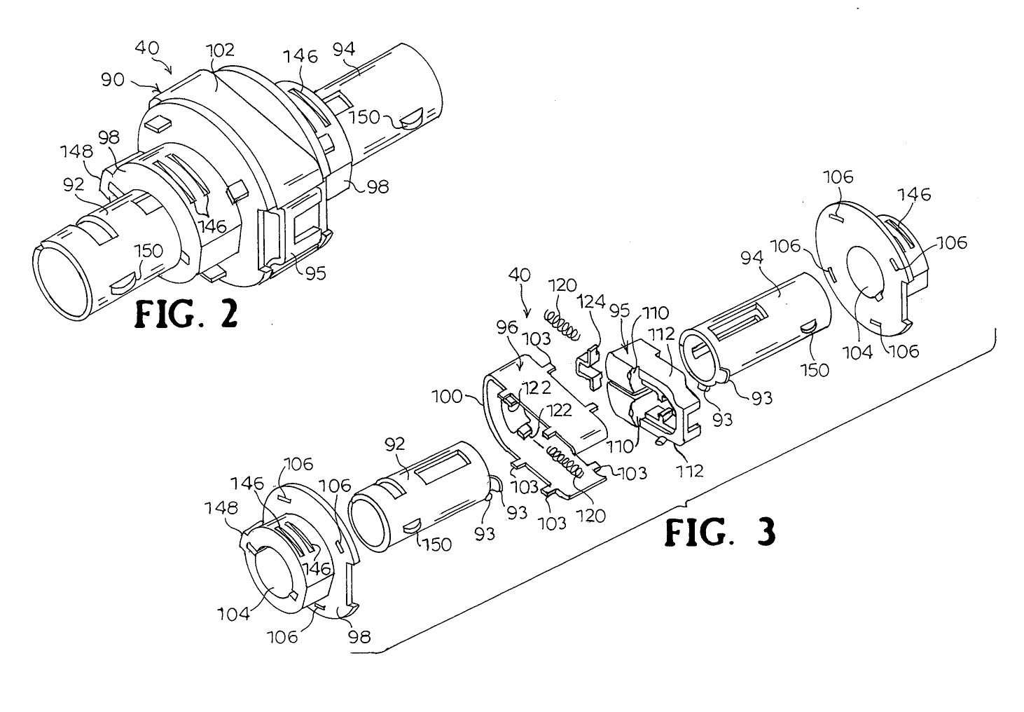

Referring now to FIGS. 2 and 3, the chassis 40 comprises a housing 90 for accommodating a U-shaped retractor 95 and opposed rollback sleeves 92, 94. The housing 90 includes a case 96 and opposed end caps 98. The case 96 is formed in a U-shaped configuration having a base 100 and a pair of legs 102 formed integrally with the base 100. The legs 102 have inwardly bent ends 101. Two pairs of opposed tabs 103 extend transversely from each leg 102.

The end caps 98 are generally circular and have a central axial opening 104. Four spaced notches 106 are formed in the end caps 98 for receiving the tabs 103 on the case 96.

The retractor 95 is formed with a base 108 having a cam surface 110 on each side and a pair of spaced, parallel arms 112. The ends of the arms 112 are formed with a pair of opposed outer lips 114 and a pair of opposed inner lips 116. The lips 114, 116 are preferably spaced apart by about ⅜ inches, which is the difference between the standard door backset distances of 2⅜ inches and 2¾ inches. As will be described below, when the outer set of lips have been engaged, the lockset will be maintained at the backset distance of 2¾ inches. When the inner set of lips is used, the backset distance will have been adjusted by the full difference in standard door backset distance to 2⅜ inches. However, it is understood that the present invention is not so limited and that more or differently spaced lips could be utilized to accommodate other backset distances.

The sleeves 92, 94 are each formed with a pair of cramming elements 93 at one end. The camming element 93 are formed by rolling back portions of the sleeves 92, 94 which extend from the end of the cylindrical portions. The sleeves are rotatably received in the openings 104 in the end caps 98.

In assembling the components of the chassis 40, the rollback sleeves 92, 94 are positioned so that the cramming elements 93 are located adjacent the cam surfaces 110 on each side of the retractor 95. The sleeves 92, 94 and retractor 95 are then located in the case 96 between the legs 102 and close to the inner surface of the base 100. The ends of two springs 120 are positioned over a pair of spaced posts 122 extending outwardly from the base 100 of the case 96. The other ends of the springs 120 engage a retainer 124, which fits in a corresponding opening in the rear of the retractor 95 thereby placing the springs 120 in a contained position for subsequent compression. To complete the housing 90, the end caps 98 are then slipped over the sleeves 92, 94 with the tabs 103 on the case 96 being inserted in the notches 106 in the end caps 98 and twisted. The retractor 95, the inward ends of the sleeves 92, 94, the springs 120 and the retainer 124 are contained within the housing 90. The sleeves 92, 94 extend outwardly from the openings 104 in the end caps 98. In this arrangement, the lips 114, 116 of the retractor 95 are exposed through the housing 90.

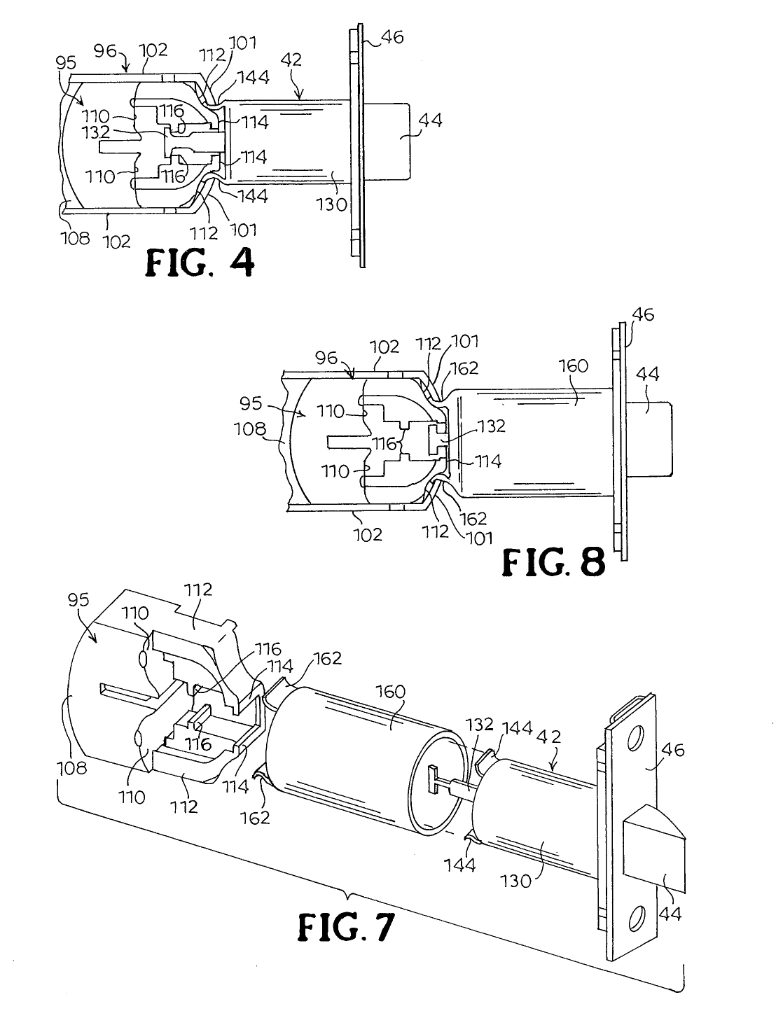

Referring now to FIG. 4, the latch assembly 42 includes a latch case 130 which is secured at one end to the face plate 46. The latchbolt 44 is contained partially within the latch case 130 and extends outwardly of the latch case to the extended position and through an opening in the face plate 46. The latchbolt 44 is retractable into the latch case 130 to a retracted, or unlatched, position. Thus, the latchbolt 44 is movable between the extended or latched position and the retracted or unlatched position. The latch bolt 44 includes a bolt tail 132 which extends from the rear of the latch case 130. The end of the bolt tail 132 is T-shaped and has arms 134, 135. The bolt tail 132 is designed to be positioned through opening of the retractor housing 90 with the arms 134, 135 located behind the lips 114, 116 of the retractor 95. As shown in FIG. 4, the bolt tail 132 is adapted to be of a length to allow the arms 134, 135 to engage behind the inner lips 116 of the retractor 95. In this arrangement, upon rotation of one of the sleeves 92, 94, the cramming elements 93 will engage the cam surfaces 110 on the retractor 95 to urge the retractor 95 inwardly against the biasing of the springs 120. As the retractor 95 is moved inwardly, the bolt tail 132 is pulled with the retractor 95 to withdraw the latchbolt 44 to the retracted position.

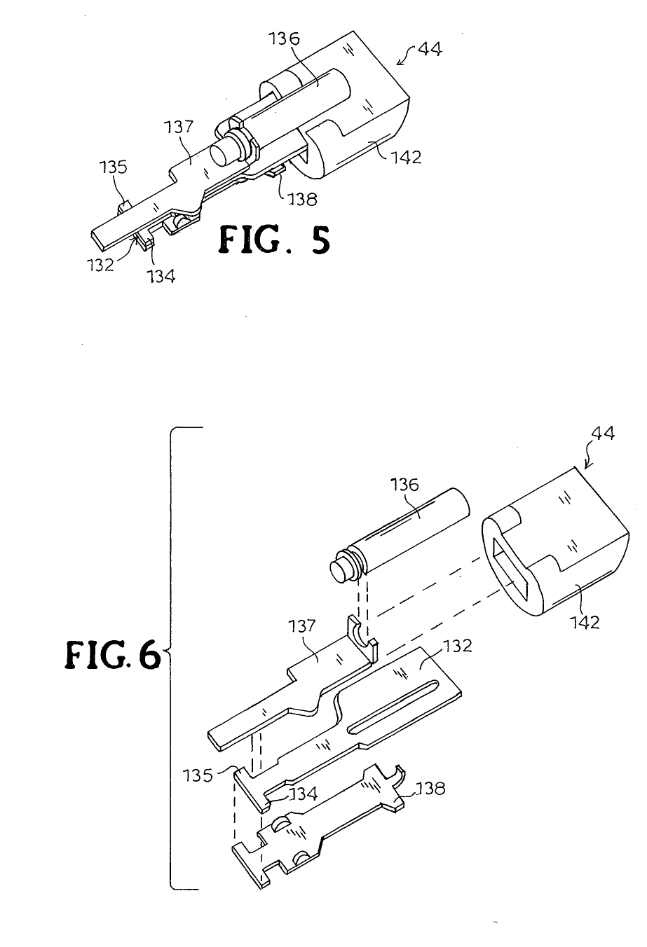

Another embodiment of the latch bolt 44 according to the present invention is shown in FIGS. 5 and 6. This embodiment includes a deadlocking function. The latchbolt 44 comprises a bolt tail 132, a deadlatch 136, a deadlatch tail 137, and a deadlocking release lever 138. The bolt tail 132 is secured within a slot 140 formed in the rear of the head 142 of the latchbolt 44. The deadlatch 136 is connected to the deadlatch tail 137. The deadlatch 136 and deadlatch tail 137 and deadlocking release lever 138 reciprocate relative to each other and with respect to the bolt tail 132. In use, this embodiment of the lath bolt 44 functions in a conventional manner with the deadlatch 136 being held in the retracted position when the door is closed and preventing latchbolt 44 from being pushed to the retracted position.

In assembling the components of the cylindrical lockset assembly 20 of FIG. 1, the latch assembly 42 is first positioned within an opening in the edge of a door. The edge opening communicates with a larger transverse opening in the door. The chassis 40 is inserted through the larger opening. As the chassis 40 is moved into the larger opening, the chassis 40 engages and becomes attached to ears 144 extending from the rear of the latch case 130, which fit behind the bent ends 101 of the legs 102 of the case 96. In this position, the housing 90 is located within the door opening and the sleeves 92, 94 extend from opposite sides of the door. The bolt tail 132 is then attached to the inner lips 116 of the retractor 95 in the manner previously described and the face plate 46 is secured to the edge of door.

According to the present invention, mounting of the latch assembly 42 to the chassis 40 may also involve the step of selectively modifying the latch case according to a larger backset of the door. Referring to FIGS. 7 and 8, this is accomplished by first slipping an auxiliary latch case 160, or sleeve, over the original latch case 130. The auxiliary latch case 160 is longer, but the bolt tail 132 is dimensioned so that the bolt tail extends from the rear of the auxiliary latch case 160. It is understood that, according to the present invention, when using a latch assembly with a deadlocking function as described above, the deadlatch tail 137 and the deadlocking release lever 138 are also longer. The modified latch assembly may then be connected to the chassis 40 by engaging the ears 162 extending from the rear of the auxiliary latch case 160 behind the bent ends 101 of the legs 102 of the case 96. The bolt tail 132 is then attached to the outer lips 114 of the retractor 95 in the manner previously described, and the face plate 46 is secured to the edge of the door.

Next, the outside rose plate 32 is slid over the outside end cap 98. As seen in FIG. 2, both end caps 98 have longitudinally-spaced lateral grooves 146 for receiving the rose plates 26, 32. The rose plates 26, 32 are adapted to be engaged in either one of the two grooves 146 in the end caps 98 to accommodate different door thicknesses. The outside rose plate 32 has an oblong central opening 50. The oblong opening 50 has a larger portion of sufficient dimension to allow the rose plate 32 to fit over the outside end cap 98 of the latch housing 90. The oblong central opening 50 also has two opposed flats which define a narrower portion of the oblong central opening 50. This shape of the opening 50 allows the outside rose plate 32 to be assembled eccentrically with respect to the housing 90 with the narrower portion of the oblong central opening 50 centered over the housing 90 and the flats seated in one set of grooves 146. The outside rose plate 32 is thus aligned with the appropriate groove 146 in the end cap 98, the outermost groove for a thick door or the innermost groove for a thin door, and moved laterally to a concentric position with respect to the housing 90. Once the outside rose plate 32 is so engaged, the housing 90 is fixed rotationally and axially with respect to the outside rose plate 32. The outside end cap 98 of the housing 90 also includes opposed longitudinal ribs 148 and the oblong central opening 50 in the outside rose plate 32 includes opposed notches. The notches are adapted to receive the corresponding longitudinal rib 148 when the outside rose plate 32 is engaged in either of the sets of grooves 146 as described above. This configuration further strengthens the assembly against rotation of the outside rose plate 32 with respect to the housing 90.

The outside rose 34 fits against the outside rose plate 32. Openings in the outside rose plate 32 are aligned with threaded holes in the outside rose 34 for use with screws for securing the outside rose plate 32 to the outside rose 34.

The inside rose plate 26 is secured to the inside rose 28 and then moved over the inside end cap 98 and against the door surface. Bolt holes in the inside rose 28 are aligned with threaded bolt holes of the outside rose 34. The threaded ends of the bolts 56 are then passed through the unthreaded holes in the inside rose 28 and into the threaded holes of the outside rose 34. The bolts 56 are then tightened to draw the rose plates 26, 32 and roses 28, 34 to a secure assembled position on opposite sides of the door whereby the heads of the bolts 52 come to rest in countersunk holes in the outer face of the inside rose 28. It is noted that in attaching the roses 28, 34 in the manner described above, protrusions on the sleeves 92, 94 are aligned with corresponding slots (not shown) in the spindles 68, 70 such that the sleeves 92, 94 and spindles 68, 70 rotate together within the lockset assembly 20.

To complete the assembly, an inside rose scalp 152 is slipped over the inside spindle 68 and the inside rose 28 and the inside lever 30 is secured onto the inside spindle 68. Similarly, an outside rose scalp 154 is placed over the outside spindle 70 and the outside rose 34 and the outside lever 36 is secured onto the spindle 70. In attaching the levers 30, 36, the axial hub openings 79, 81 are positioned over the spindles 68, 70, which include a pair of diametrically opposed longitudinal slots 156. The slots 156 receive corresponding ribs formed in the levers 30, 36 to facilitate rotation of the spindles 68, 70 upon actuation of the levers 30, 36. The hub openings 79, 81 are also formed with transverse depressions and are positioned for alignment with transverse slots formed in spindles 68, 70. Spring-biased detents or catch plates (not shown) extend through the slots and into the depressions to retain the levers 30, 36 on the sleeves 92, 94.

Although the present invention has been shown and described in considerable detail with respect to only a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings. For example, although a cylindrical lock is shown, the novel retractor shown and described herein may be used with any type of latchset or lockset for accommodating two or more backset distances. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

We claim:

1. A lock assembly, comprising:
a housing;
a latchbolt including an attachment member;
a retractor element disposed within the housing for linear reciprocating movement, the retractor element including a first attachment location formed in the retractor element in a first position relative to the axis of reciprocation of the retractor element, and a second attachment location formed in the retractor element in a second position relative to the axis of reciprocation of the retractor element and spaced from the first attachment location by a distance along the axis of reciprocation of the retractor element, the attachment member selectively engageable with the retractor element at either the first attachment location or the second attachment location for movement together with the retractor element; and
an operator operatively connected to the retractor element for facilitating selective reciprocation of the retractor element for moving the latchbolt between a latched position and an unlatched position.
